(19) United States
(12) Patent Application Publication
(10) Pub. No.: US 2025/0098680 A1
(43) Pub. Date: Mar. 27, 2025

(54) A METHOD OF PLANT TREATMENT WITH QUINOLINE ALKALOIDS AND PESTICIDE COMPOSITIONS THEREOF

(71) Applicant: METABOLIC INSIGHTS LTD., Ness-Ziona (IL)

(72) Inventors: David PANIK, Rehovot (IL); Ido KORMAN, Sde Nitzan (IL)

(21) Appl. No.: 18/730,771

(22) PCT Filed: Jan. 16, 2023
(86) PCT No.: PCT/IL2023/050045

§ 371 Date: Jul. 21, 2024

(30) Foreign Application Priority Data
Jan. 21, 2022 (IT) 102022000001031

(51) Int. Cl. A01N 43/90

(52) U.S. Cl. CPC A01N 43/90

(57) ABSTRACT

A method for controlling, preventing, reducing or eradicating the instances of plant-pathogen infestation or plant diseases on a plant, plant organ, plant part, or plant propagation material is provided. The method comprises applying to a plant, plant part, plant organ or plant propagation material, or to soil surrounding said plant, a pesticidally effective amount of any one of compounds selected from the group consisting of dihydroquinidine and dihydroquinine, or agriculturally acceptable salts thereof, or a pesticide composition comprising any one of them, wherein said plant-pathogen is a member selected from a Heterokontophyta of the class Oomycota and a Heterokontophyta of the order Peronosporales. A pesticide composition comprising any one of the compounds selected from the group consisting of dihydroquinidine and dihydroquinine, or an agriculturally acceptable salt thereof as an active pesticidal ingredient is further provided.

### TECHNICAL FIELD

The present invention relates in general to pesticides and their agricultural uses.

### BACKGROUND

Plant pests and diseases represent major challenges to productivity in modern agriculture. Soil-borne plant pathogens cause crucial damage to agricultural crops.

Phytophthora spp. is an obligatory plant fungal like pathogen which belongs to phylogenetic lineage of eukaryotic microorganisms called Oomycetes. Phytophthora infestans is a serious potato disease known as potato blight resulting in foliage blight and rot of tubers. The disease can cause complete loss of a potato harvest (Sedláková et al., 2012). Phytophthora attacks the aerial parts of many plant species, and it is the major cause of leaf blight, canker fruit rot diseases in tomato, pumpkins and other crops.

Pseudoperonospora spp. is an obligatory plant fungal like pathogen which belongs to phylogenetic lineage of Oomycetes. Pseudoperonospora spp. causes devastating downy mildew diseases on various plants such as cucurbits, watermelons, squash (Savory et al., 2011).

The number of available active ingredients for crop protection purposes against these diseases is diminishing from year to year due to increasing pest resistance, erratic climatic conditions and mounting regulatory pressure. New active ingredients are urgently needed for development of novel environmentally sustainable crop protection solutions.

Che et al., 2020 describes certain insecticidal activity against Mythimna separata (northern armyworm).

BE365389A describes water solution preparation of Cinchona alkaloids as a manufacturing method.

Yang et al., 2019 and Chen et al., 2021 describes anti-fungal activity of various synthetic analogues of quinoline alkaloids against mainly Basidomycota and Ascomycota fungi while the present invention is directed at Oomycota.

JP2003081945A describes that quinine (anti-malaria drug) has fungicidal bioactivity against Cucumber downey mildew. The present invention is directed at structurally different dihydroquinidine and dihydroquinine.

### SUMMARY OF THE INVENTION

In one aspect of the present invention, a method for controlling, preventing, reducing or eradicating plant-pathogen infestation or instances thereof, or plant diseases, on a plant, plant organ, plant part, or plant propagation material comprises applying to a plant, plant organ or plant propagation material, or to soil surrounding said plant, an effective amount of any one of compounds selected from the group consisting of dihydroquinidine and dihydroquinine, or agriculturally acceptable salts thereof, or a pesticide composition comprising at least one of said compounds, wherein said plant-pathogen is a member selected from a Heterokontophyta of the class Oomycota and a Heterokontophyta of the order Peronosporales.

In another aspect, a method for controlling, preventing, reducing or eradicating instances of plant-pathogen infestation or plant diseases, on a plant, plant organ, plant part, or plant propagation material, comprises applying to a plant, plant part, plant organ or plant propagation material, or to soil surrounding said plant, a pesticide composition comprising at least one of the compounds selected from dihydroquinidine, and dihydroquinine, or agriculturally acceptable salts thereof.

In some embodiments, dihydroquinidine, dihydroquinine, or agriculturally acceptable salts thereof, or a pesticide composition comprising at least one of said compounds are directly applied to a plant-pathogen which is a member selected from: a Heterokontophyta of the class Oomycota and a Heterokontophyta of the order Peronosporales. In other embodiments, dihydroquinidine, dihydroquinine, or agriculturally acceptable salts thereof, or a pesticide composition comprising at least one of said compounds, is used in a method for controlling, preventing, reducing or eradicating plant-pathogen infestation or instances thereof, or plant diseases, on a plant, plant organ, plant part, or plant propagation material, wherein said plant-pathogen is a member selected from a Heterokontophyta of the class Oomycota and a Heterokontophyta of the order Peronosporales.

Various embodiments may allow various benefits and may be used in conjunction with various applications. The details of one or more embodiments are set forth in the accompanying figures and the description below. Other features, objects and advantages of the described invention will be apparent from the description and drawings and from the claims.

### BRIEF DESCRIPTION OF DRAWINGS

Disclosed embodiments will be understood and appreciated more fully from the following detailed description taken in conjunction with the appended figures.

FIG. 1 shows Experiment 580 results on the effect of dihydroquinidine on the Phytophthora infestans disease severity in tomato seedlings, seven days after infection, under greenhouse conditions, determined as % disease severity, using preventative approach and application via spraying. The dihydroquinidine application dosage is indicated in ppm. Conditions of the experiment: Wettable Powder (WP) Fungicide containing 50% dimethomorph (Acrobat®, BASF); p<0.05; **, p<0.01; ***, p<0.001; and non-significant (n.s.) difference vs. untreated control; ppm-parts per million; Formulation 15 at small scale (n=24) (see Example 2).

FIG. 2 shows Experiment 633 results on the effect of dihydroquinidine on the Phytophthora infestans disease severity in tomato seedlings, seven days after infection, under greenhouse conditions, determined as % disease severity, using preventative approach and application via spraying. The dihydroquinidine application dosage is indicated in ppm. Conditions of the experiment: Wettable Powder (WP) Fungicide containing 50% dimethomorph (Acrobat®, BASF); p<0.05; **, p<0.01; ***, p<0.001; and non-significant (n.s.) difference vs. untreated control; ppm-parts per million; Formulation 15 at small scale (n=24) (see Example 2).

FIG. 3 shows Experiment 654 results on the effect of dihydroquinidine on the Phytophthora infestans disease severity in tomato seedlings, seven days after infection, under greenhouse conditions, determined as % disease severity, using preventative approach and application via spraying. The dihydroquinidine application dosage is indicated in ppm. Conditions of the experiment: Wettable Powder (WP) Fungicide containing 50% dimethomorph (Acrobat®, BASF); p<0.05; **, p<0.01; ***, p<0.001; and non-significant (n.s.) difference vs. untreated control; ppm-parts per million; Formulation 15 at small scale (n=24) (see Example 2).

FIG. 4 shows Experiment 580 results on the effect of dihydroquinidine on the Phytophthora infestans disease severity in tomato seedlings, seven days after infection, under greenhouse conditions, determined as % disease severity, using preventative approach and application via spraying. The dihydroquinidine application dosage is indicated in ppm. Conditions of the experiment: Wettable Powder (WP) Fungicide containing 50% dimethomorph (Acrobat®, BASF); p<0.05; **, p<0.01; ***, p<0.001; and non-significant (n.s.) difference vs. untreated control; ppm-parts per million; Formulation 16 at small scale (n=24) (see Example 3).

### DETAILED DESCRIPTION

It has been found in accordance with the present invention that the chemical compounds dihydroquinidine and dihydroquinine, or agriculturally acceptable salts thereof, are potent pesticides against Heterokontophyta fungi.

The CAS registry identifies the compound dihydroquinidine (CAS No. 1435-55-8), which is also known as (+)-hydroquinidine, under the following IUPAC name: (S)-[(2R,4S,5R)-5-ethyl-1-azabicyclo[2.2.2]octan-2-yl](6-methoxyquinolin-4-yl) methanol and with the following structural formula:

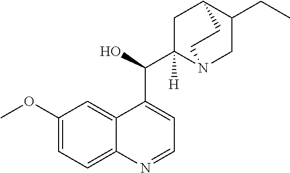 [SMILES: CCC1C[N@]2CC[C@H]1C[C@@H]2[C@H](O)c1ccnc2ccc(OC)cc12]

The CAS registry identifies the compound dihydroquinine (CAS No. 522-66-7), which is a diastereomer of dihydroquinidine, under the following IUPAC name: (R)-[(2S,4S,5R)-5-ethyl-1-azabicyclo[2.2.2]octan-2-yl](6-methoxyquinolin-4-yl) methanol and with the following structural formula:

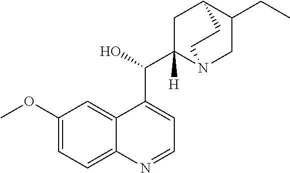 [SMILES: CCC1C[N@]2CC[C@H]1C[C@H]2[C@@H](O)c1ccnc2ccc(OC)cc12]

Dihydroquinidine and dihydroquinine are a member of the class of quinoline alkaloids. Different quinoline alkaloids have been shown previously as having wide range of activities including antimalarial, anticancer, anti-oxidant, anti-fungal, etc. (Yang et al., 2019).

The present invention provides in one aspect a method for controlling, preventing, reducing or eradicating plant-pathogen infestation or instances thereof, or plant diseases, on a plant, plant organ, plant part, or plant propagation material, the method comprising applying to a plant, plant organ or plant propagation material, or to soil surrounding said plant, a pesticidally effective amount of any one of the compounds selected from the group consisting of dihydroquinidine and dihydroquinine, or agriculturally acceptable salts of any one of them, wherein said plant-pathogen is a member selected from a Heterokontophyta of the class Oomycota and a Heterokontophyta of the order Peronosporales. In another aspect, the present invention provides a method for controlling, preventing, reducing or eradicating plant-pathogen infestation or instances thereof, or plant diseases, on a plant, plant organ, plant part, or plant propagation material, the method comprising applying to a plant, plant organ or plant propagation material, or to soil surrounding said plant, a pesticide composition comprising at least one of the compounds selected from dihydroquinidine and dihydroquinine, or agriculturally acceptable salts thereof, wherein said plant-pathogen is a member selected from a Heterokontophyta of the class Oomycota and a Heterokontophyta of the order Peronosporales.

In another aspect, the present invention provides a method for controlling, preventing, reducing or eradicating instances of plant-pathogen infestation on a plant, plant organ, plant part, or plant propagation material, the method comprising applying to a plant, plant organ or plant propagation material, or to soil surrounding said plant, a pesticidally effective amount of any one of the compounds selected from the group consisting of dihydroquinidine and dihydroquinine, or agriculturally acceptable salts of any one of them, wherein said plant-pathogen is a member selected from a Heterokontophyta of the order Peronosporales.

The plant treatment method of the present invention according to anyone of the embodiments disclosed herein is useful for example against the following diseases selected from potato blight, Phytophthora palmivora in cacao, canker fruit rot diseases in tomato and pumpkins, Phytophthora spp. crown and collar rot in pome and stone fruit.

In another embodiment, the plant-pathogen is a member of the class Oomycota of an order selected from Lagenidiales, Leptomitales, Peronosporales, Rhipidiales and Saprolegniales. In a particular embodiment, the plant-pathogen is a member of the class Oomycota of the order Peronosporales.

In still another embodiment, the Peronosporales plant-pathogen is a member of a family selected from Lagenidiaceae, Olpidiosidaceae, Sirolpidiaceae, Leptomitaceae, Albuginaceae, Peronosporaceae, Pythiaceae, Rhipidaceae, Ectrogellaceae, Haliphthoraceae, Leptolegniellaceae and Saprolegniaceae. In a specific embodiment, the plant-pathogen is a member of the family Peronosporaceae.

In certain embodiments, the Peronosporaceae plant-pathogen is a member of a genus selected from Baobabopsis, Basidiophora, Benua, Bremia, Calycofera, Eraphthora, Graminivora, Hyaloperonospora, Nothophytophthora, Novotelnova, Paraperonospora, Perofascia, Peronosclerospora, Peronospora, Phytophthora, Plasmopara, Plasmoverna, Protobremia, Pseudoperonospora, Sclerophthora, Sclerospora and Viennotia.

In some embodiments, the Peronosporaceae plant-pathogen is a member of the genus Phytophthora. In a specific embodiment, the Phytophthora plant-pathogen is selected from Phytophthora acerina, Phytophthora agathidicida, Phytophthora alni, Phytophthora x alni, Phytophthora alticola, Phytophthora amaranthi, Phytophthora amnicola, Phytophthora amnicola x moyootj, Phytophthora andina, Phytophthora aquimorbida, Phytophthora arecae, Phytophthora arenaria, Phytophthora cf. arenaria, Phytophthora aff. arenaria, Phytophthora asiatica, Phytophthora asparagi, Phytophthora aff. asparagi, Phytophthora attenuata, Phytophthora austrocedrae, Phytophthora balyanboodja, Phytophthora batemanensis, Phytophthora bilorbang, Phytophthora bisheria, Phytophthora bishii, Phytophthora boehmeriae, Phytophthora boodjera, Phytophthora borealis, Phytophthora botryosa, Phytophthora cf. botryosa, Phytophthora aff. botryosa, Phytophthora brassicae, Phytophthora cactorum, Phytophthora cactorum var. applanata, Phytophthora cactorum x hedraiandra, Phytophthora cajani, Phytophthora cambivora, Phytophthora capensis, Phytophthora capsici, Phytophthora aff. capsici, Phytophthora captiosa, Phytophthora castaneae, Phytophthora castanetorum, Phytophthora chlamydospora, Phytophthora chrysanthemi, Phytophthora cichorii, Phytophthora aff. cichorii, Phytophthora cinnamomi, Phytophthora cinnamomi var. cinnamomi, Phytophthora cinnamomi var. parvispora, Phytophthora cinnamomi var. robiniae, Phytophthora citricola, Phytophthora aff. citricola, Phytophthora citrophthora, Phytophthora citrophthora var. clementina, Phytophthora aff. citrophthora, Phytophthora clandestina, Phytophthora cocois, Phytophthora colocasiae, Phytophthora condilina, Phytophthora constricta, Phytophthora cooljarloo, Phytophthora crassamura, Phytophthora cryptogea, Phytophthora aff. cryptogea, Phytophthora cuyabensis, Phytophthora cyperi, Phytophthora dauci, Phytophthora aff. dauci, Phytophthora drechsleri, Phytophthora drechsleri var. cajani, Phytophthora elongata, Phytophthora cf. elongata, Phytophthora erythroseptica, Phytophthora erythroseptica var. pisi, Phytophthora aff. erythroseptica, Phytophthora estuarina, Phytophthora europaea, Phytophthora fallax, Phytophthora flexuosa, Phytophthora fluvialis, Phytophthora fluvialis x moyootj, Phytophthora foliorum, Phytophthora formosa, Phytophthora formosana, Phytophthora fragariae, Phytophthora fragariaefolia, Phytophthora frigida, Phytophthora gallica, Phytophthora gemini, Phytophthora gibbosa, Phytophthora glovera, Phytophthora gonapodyides, Phytophthora gondwanensis, Phytophthora gregata, Phytophthora cf. gregata, Phytophthora hedraiandra, Phytophthora aff. hedraiandra, Phytophthora x heterohybrida, Phytophthora heveae, Phytophthora hibernalis, Phytophthora himalayensis, Phytophthora himalsilva, Phytophthora aff. himalsilva, Phytophthora humicola, Phytophthora aff. humicola, Phytophthora hydrogena, Phytophthora hydropathica, Phytophthora idaei, Phytophthora ilicis, Phytophthora x incrassata, Phytophthora infestans, Phytophthora aff. infestans, Phytophthora inflata, Phytophthora insolita, Phytophthora cf. insolita, Phytophthora intercalaris, Phytophthora intricata, Phytophthora inundata, Phytophthora ipomoeae, Phytophthora iranica, Phytophthora irrigata, Phytophthora katsurae, Phytophthora kelmania, Phytophthora kernoviae, Phytophthora kwongonina, Phytophthora lactucae, Phytophthora lacustris, Phytophthora lacustris x riparia, Phytophthora lateralis, Phytophthora lili, Phytophthora litchii, Phytophthora litoralis, Phytophthora litoralis x moyootj, Phytophthora macilentosa, Phytophthora macrochlamydospora, Phytophthora meadii, Phytophthora aff. meadii, Phytophthora medicaginis, Phytophthora medicaginis x cryptogea, Phytophthora megakarya, Phytophthora megasperma, Phytophthora melonis, Phytophthora mengei, Phytophthora mexicana, Phytophthora cf. mexicana, Phytophthora mirabilis, Phytophthora mississippiae, Phytophthora morindae, Phytophthora moyootj, Phytophthora moyootj x fluvialis, Phytophthora moyootj x litoralis, Phytophthora moyootj x thermophila, Phytophthora x multiformis, Phytophthora multivesiculata, Phytophthora multivora, Phytophthora nagaii, Phytophthora nemorosa, Phytophthora nicotianae, Phytophthora nicotianae var. parasitica, Phytophthora nicotianae x cactorum, Phytophthora niederhauserii, Phytophthora cf. niederhauserii, Phytophthora obscura, Phytophthora occultans, Phytophthora oleae, Phytophthora ornamentata, Phytophthora pachypleura, Phytophthora palmivora, Phytophthora palmivora var. palmivora, Phytophthora parasitica, Phytophthora parasitica var. nicotianae, Phytophthora parasitica var. piperina, Phytophthora parsiana, Phytophthora aff. parsiana, Phytophthora parvispora, Phytophthora x pelgrandis, Phytophthora phaseoli, Phytophthora pini, Phytophthora pinifolia, Phytophthora pisi, Phytophthora pistaciae, Phytophthora plurivora, Phytophthora pluvialis, Phytophthora polonica, Phytophthora porri, Phytophthora primulae, Phytophthora aff. primulae, Phytophthora pseudocryptogea, Phytophthora pseudolactucae, Phytophthora pseudorosacearum, Phytophthora pseudosyringae, Phytophthora pseudotsugae, Phytophthora aff. pseudotsugae, Phytophthora psychrophila, Phytophthora quercetorum, Phytophthora quercina, Phytophthora quininea, Phytophthora ramorum, Phytophthora rhizophorae, Phytophthora richardiae, Phytophthora riparia, Phytophthora rosacearum, Phytophthora aff. rosacearum, Phytophthora rubi, Phytophthora sansomea, Phytophthora sansomeana, Phytophthora aff. sansomeana, Phytophthora x serendipita, Phytophthora sinensis, Phytophthora siskiyouensis, Phytophthora sojae, Phytophthora stricta, Phytophthora sulawesiensis, Phytophthora syringae, Phytophthora tabaci, Phytophthora tentaculata, Phytophthora terminalis, Phytophthora thermophila, Phytophthora thermophila x amnicola, Phytophthora thermophila x moyootj, Phytophthora trifolii, Phytophthora tropicalis, Phytophthora cf. tropicalis, Phytophthora tubulina, Phytophthora tyrrhenica, Phytophthora uliginosa, Phytophthora undulata, Phytophthora uniformis, Phytophthora vignae, Phytophthora vignae f. sp. adzukicola, Phytophthora virginiana and Phytophthora vulcanica. In a further specific embodiment, the plant-pathogen is the species Phytophthora infestans.

In some embodiments, the Peronosporaceae plant-pathogen is a member of the genus Pseudoperonospora. In a specific embodiment, the Pseudoperonospora plant-pathogen is selected from Pseudoperonospora cannabina, Pseudoperonospora cubensis and Pseudoperonospora humuli.

In a particular embodiment, the present invention provides a method for controlling, preventing, reducing or eradicating any one of the Oomycota plant pathogens described above, in particular Phytophthora infestans, the method comprising applying to a plant, plant organ or plant propagation material, or to soil surrounding said plant, a pesticidally effective amount of any one of the compounds selected from the group consisting of dihydroquinidine and dihydroquinine, or agriculturally acceptable salts thereof.

In certain embodiments, the pesticide composition of any one of the above embodiments further comprises an agriculturally suitable or acceptable solvent or solubilising agent. In other certain embodiments, the agriculturally acceptable solvent or solubilising agent is a water-miscible solvent capable of dissolving or solubilising dihydroquinidine and dihydroquinine.

In some embodiments, the water-miscible solvent capable of dissolving or solubilising dihydroquinidine and dihydroquinine is a polar solvent. Non-limiting examples of said solvent include: an alcohol, a ketone, a lactone, a keto-alcohol, a glycol, a glycoether, an amide, an alkanolamine, a sulfoxide and a pyrrolidone. In particular embodiments, the composition of any one of the above embodiments comprises a solvent selected from dimethyl-sulfoxide or ethanol. In specific embodiments, the composition further comprises a polysorbate-type non-ionic surfactant, such as polysorbate 20.

The pesticide composition of the present invention may be formulated into a formulation to facilitate application of the active pesticidal ingredient. Non-limiting examples of said formulation include: water-miscible formulations, such as a suspension concentrate (SC), a capsule suspension (CS), water-dispersible granules (WG), an emulsifiable concentrate (EC), a wettable powder (WP), a soluble (liquid) concentrate (SL), or a soluble powder (SP).

The composition or formulation of the present invention may further comprise at least one adjuvant, carrier, diluent, and/or surfactant. Non-limiting examples of adjuvants are activator adjuvants, such as cationic, anionic or non-ionic surfactants, oils and nitrogen-based fertilisers capable of improving activity of the pesticide product. Oils may be crop oils, such as paraffin or naphtha-based petroleum oil, crop oil concentrates based on emulsifiable petroleum-based oil, and vegetable oil concentrates derived from seed oil, usually cotton, linseed, soybean, or sunflower oil, used to control grassy weeds. Nitrogen-based fertilisers may be ammonium sulphate or urea-ammonium nitrate.

A non-limiting example of a polysaccharide adjuvant used also as a thixotropic agent in the compositions of the present embodiments, is Xanthan gum (commercially available under trademark KELZAN® by CP Kelco), which is produced from simple sugars using a fermentation process and derives its name from the species of bacteria used, Xanthomonas campestris. Oils used as adjuvants may be crop oils, such as paraffin or naphtha-based petroleum oil, crop oil concentrates based on emulsifiable petroleum-based oil, and vegetable oil concentrates derived from seed oil, usually cotton, linseed, soybean, or sunflower oil, used to control grassy weeds. Nitrogen-based fertilisers may be ammonium sulphate or urea-ammonium nitrate.

Non-limiting examples of solubilising agents or solvents are petroleum-based solvents, the aforementioned oils, liquid mixtures of fatty acids, ethanol, glycerol and dimethyl sulfoxide. The agriculturally acceptable solvent or solubilising agent may be a water-miscible solvent capable of dissolving or solubilising dihydroquinidine and dihydroquinine, such as a polar solvent, e.g., an alcohol, a ketone, a lactone, a keto-alcohol, a glycol, a glycoether, an amide, an alkanolamine, a sulfoxide and a pyrrolidone. Non-limiting examples of carriers are precipitated silica, colloidal silica, attapulgite, China clay, talc, kaolin and combinations thereof.

The pesticide composition or formulation of the present invention may further comprise a diluent, such as lactose, starch, urea, water soluble inorganic salts and combination thereof. The pesticide composition or formulation may further comprise one or more surfactants, such as polysorbate-type non-ionic surfactant, for example Polysorbate 20 or trisiloxane non-ionic surfactant, styrene acrylic dispersant polymers, acid resin copolymer based dispersing agents, potassium polycarboxylate, sodium alkyl naphthalene sulphonate blend, sodium diisopropyl naphthalene sulphonate, sodium salt of naphthalene sulphonate condensate, lignin sulfonate salts and combinations thereof.

Trisiloxane non-ionic surfactants or polyether dimethyl siloxanes (PEMS), often referred to as super-spreaders or super-wetters, are added to pesticides to enhance their activity and the rain fastness of the active substance by promoting rapid spreading over the hydrophobic surfaces of leaves. Some spreaders of the modified trisiloxane type combine a very low molecular weight trisiloxane with a polyether group and capable of reducing surface tension and rapidly spreading on difficult to wet surfaces.

The active agent, composition, or formulation comprising it, is applied in the method of any one of the above embodiments to the plant or part, organ or plant propagation material thereof by spraying, immersing, dressing, coating, pelleting or soaking.

In certain embodiments, the concentration of dihydroquinidine and dihydroquinine in the present invention, in the composition or formulation comprising it may be in the range of 10-2000, 10-1500, 10-1000, 10-900, 10-800, 10-700, 10-600, 10-500, 10-400, 10-300, 10-200, 10-100, 10-90, 10-80, 10-70, 10-60, 10-50, 10-40, 10-30, 10-20, 20-2000, 20-1500, 20-1000, 20-900, 20-800, 20-700, 20-600, 20-500, 20-400, 20-300, 20-200, 20-100, 20-90, 20-80, 20-70, 20-60, 20-50, 20-40, 20-30, 20-20. 30-2000, 30-1500, 30-1000, 30-900, 30-800, 30-700, 30-600, 30-500, 30-400, 30-300, 30-200, 30-100, 30-0, 30-100, 30-90, 30-80, 30-70, 30-60, 30-50, 30-40, 40-2000, 40-1500, 40-1000, 40-900, 40-800, 40-700, 40-600, 40-500, 40-400, 40-300, 40-200, 40-100, 40-90, 40-80, 40-70, 40-60, 40-50, 50-2000, 50-1500, 50-1000, 50-900, 50-800, 50-700, 50-600, 50-500, 50-400, 50-300, 50-200, 50-100, 50-90, 50-80, 50-70, 50-60, 60-2000, 60-1500, 60-1000, 60-900, 60-800, 60-700, 60-600, 60-500, 60-400, 60-300, 60-200, 60-100, 60-90, 60-80, 60-70, 70-2000, 70-1500, 70-1000, 70-900, 70-800, 70-700, 70-600, 70-500, 70-400, 70-300, 70-200, 70-100, 70-90, 70-80, 80-2000, 80-1500, 80-1000, 80-900, 80-800, 80-700, 80-600, 80-500, 80-400, 80-300, 80-200, 80-100, 80-90, 90-2000, 90-1500, 90-1000, 90-900, 90-800, 90-700, 90-600, 90-500, 90-400, 90-300, 90-200, 90-100, 100-2000, 100-1500, 100-1000, 100-900, 100-800, 100-700, 100-600, 100-500, 100-400, 100-300, 100-200, 200-2000, 200-1500, 200-1000, 200-900, 200-800, 200-700, 200-600, 200-500, 200-400, 200-300, 300-2000, 300-1500, 300-1000, 300-900, 300-800, 300-700, 300-600, 300-500, 300-400, 400-2000, 400-1500, 400-1000, 400-900, 400-800, 400-700, 400-600, 400-500, 500-2000, 500-1500, 500-1000, 500-900, 500-800, 500-700, 500-600, 600-2000, 600-1500, 600-1000, 600-900, 600-800, 600-700, 700-2000, 700-1500, 700-1000, 700-900, 700-800, 800-2000, 800-1500, 800-1000, 800-900, 900-2000, 900-1500, 900-1000, 1000-2000, or 1000-1500 ppm.

In particular, the concentration of dihydroquinidine and dihydroquinine in the composition or formulation comprising it may be 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 1000, 1500 or 2000 ppm.

Any one of the above concentration ranges or concentrations can be used in accordance with any one of the above embodiments relating to the method of the present invention, against any one of the aforementioned pathogens and by means of any one of the above-mentioned applications.

### Definitions

The term “plant organ” as used herein refers to the leaf, stem, root, and reproductive structures. The term “plant part” as used herein refers to a vegetative plant material such as a cutting or a tuber; a leaf, flower, bark or a stem. The term “plant propagation material” as used herein refers to a seed, root, fruit, tuber, bulb, rhizome, or part of a plant. The term “pesticidal effective amount” as used herein refers to an amount of the pesticide that is able to bring about death to at least one pest, or to noticeably reduce pest growth, feeding, or normal physiological development. The terms “class”, “order”, “family”, “genus”, and “species” are used herein according to Art 3.1 of the International Code of Nomenclature for algae, fungi, and plants.

The term “comprising”, used in the claims, is “open ended” and means the elements recited, or their equivalent in structure or function, plus any other element or elements which are not recited. It should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a composition comprising x and z” should not be limited to compositions consisting only of components x and z. Also, the scope of the expression “a method comprising the steps x and z” should not be limited to methods consisting only of these steps.

Unless otherwise indicated, all numbers used in this specification are to be understood as being modified in all instances by the term “about”. Unless specifically stated, as used herein, the term “about” is understood as within a range of normal tolerance in the art, for example within two standard deviations of the mean. In one embodiment, the term “about” means within 10% of the reported numerical value of the number with which it is being used, preferably within 5% of the reported numerical value. For example, the term “about” can be immediately understood as within 10%, 9%, 8%, 7%, 6%, 5%, 4%, 3%, 2%, 1%, 0.5%, 0.1%, 0.05%, or 0.01% of the stated value. In other embodiments, the term “about” can mean a higher tolerance of variation depending on for instance the experimental technique used. Said variations of a specified value are understood by the skilled person and are within the context of the present invention. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges, for example from 1-3, from 2-4, and from 3-5, as well as 1, 2, 3, 4, 5, or 6, individually. This same principle applies to ranges reciting only one numerical value as a minimum or a maximum.

Unless otherwise clear from context, all numerical values provided herein are modified by the term “about”. Other similar terms, such as “substantially”, “generally”, “up to” and the like are to be construed as modifying a term or value such that it is not an absolute. Such terms will be defined by the circumstances and the terms that they modify as those terms are understood by those of skilled in the art. This includes, at very least, the degree of expected experimental error, technical error and instrumental error for a given experiment, technique or an instrument used to measure a value.

As used herein, the term “and/or” includes any and all combinations of one or more of the associated listed items. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

In the following description, various aspects of the present application will be described. For purposes of explanation, specific configurations and details are set forth in order to provide a thorough understanding of the present application. However, it will also be apparent to one skilled in the art that the present application may be practiced without the specific details presented herein. Furthermore, well-known features may be omitted or simplified in order not to obscure the present application.

The invention will now be illustrated by the following non-limiting Examples.

### Examples

### List of Abbreviations:

RPM—Revolutions per minute
RCF—Relative centrifugal force
CFU—Colony forming unit
PDBC—Potato dextrose broth with 20 μg/ml chloramphenicol
PDAC—Potato dextrose agar with 20 μg/ml chloramphenicol
PDAT—Potato dextrose agar with 12 μg/ml tetracycline
DMSO—Dimethyl sulfoxide
LB—Lysogeny broth broth
LBA—Lysogeny Broth agar
SCH—Schmittner medium
2:PDBC—PDBC diluted 2 fold by sterile distilled water
PDA—Potato dextrose agar
PDBT—Potato dextrose broth with 12 μg/ml tetracycline

### Example 1. Microplate-Based Screening of Dihydroquinidine and Dihydroquinine Against Phytophthora infestans

Background: Phytophthora infestans is an obligatory pathogen from Oomycetes which is very difficult to grow on synthetic medium. Therefore, the bioactivity screening system based on leaf discs prepared from detached tomato leaves were used.

Summary: dihydroquinidine or dihydroquinine dissolved in DMSO were added to tomato leaf discs infected with Phytophthora and the disease progress was monitored by visual inspection.

General description: Inoculation and maintenance on tomato leaves, preparation of spore suspension, their growth on leaf discs in microplates and inspection by magnifying glass of Phytophthora infestans severity of infection.

The following materials, methods and equipment were used:

### Method:

### A. Preparation of Tomato Seedling for Leaves Production for Inoculation

1) Use seedling pots of size 120×80×80.
2) Use standard garden earth with fertilizer.
3) Use 4 weeks old tomato seedlings.
4) Put 6 pots in a small tray.
5) Put one seedling in each pot.
6) Add water into the tray—about 100 ml for each pot. Earth should be wet, and no water should be left in the trey after 24 h.
7) Grow the tomato plants in growth room at 22° C. and 16 h light/darkness conditions.
8) When plants are grown (4 weeks after planting) transfer them to a 5 L pot and fertilize every week with.

### B. Preparation of Tomato Leaves for Inoculation

1) Put two pieces of sterile paper in a square Petri dish.
2) Work in sterile conditions.
3) Use leaves of 5 weeks old tomato plants or older.
4) Cut the leaves by a sterile scalpel.
5) Add 20 ml sterile distilled water to wet the paper (the paper should be maximally wet, but without additional dripping water).
6) Put about 6 lobes of leaves in a square Petri dish, on the wet paper (with the lower side of the leaves up).
7) Cover the plate with its lid.

### C. Preparation of Inoculum and Leaf Discs Infection

### Preparation of Sporangium Suspension

1) Put 10 lobes of tomato leaf infected with Phytophthora (4-6 days after infection), in a sterile 50 ml tube, fill in 40 ml of fridge cold, sterile, distilled water.
2) Mix the tube gently by hand, to transfer sporangium into the water, but avoid disintegration of the leaf.
3) Filter the spore suspension through 16 layers of gauze into a 50-ml tube.
4) Calculate the spore concentration-use microscope with 200× magnification. A concentration of 6000 sporangium/ml is expected.
5) Chill the tube on ice.

### D. Sporangium Wash and Concentration by Filtration

1) Prepare filtration system with membrane (0.65 micron-5 micron) and wash the membrane with sterile cold water.
2) Suspend and decant the spore suspension from the 50 ml tube slowly, into the filtration system. Use low vacuum, don't let the membrane dry-leave 4 ml unfiltered suspension on the filter.
3) Wash the spores to discard bacteria and other fungi spores (use 40 ml water to wash)—spray cold sterile water to suspend and wash the spores.
4) Repeat spore wash 5 more times. Do not let the membrane dry. Leave 4 ml unfiltered suspension.
5) Collect the spore suspension using a 1000 μl pipettor into a clean 50-ml tube.
6) Insert the membrane into the 50-ml tube mix gently to suspend the sporangium, which stick to the membrane.
7) Discard the membrane to be autoclaved.
8) Discard liquid, and disinfect the filtration system using hypochlorite for 30 min.
9) Wash the filtration system with tap water and dry the filtration system on a paper in a plastic basket.
10) Calculate the sporangium concentration-use microscope with 200× magnification-10,000-50,000 sporangium/ml concentration is expected.
11) Keep the sporangium suspension on ice.

### E. Inoculation of Spores on Detached Leaves for Maintenance of Phytophthora

1) Spray 1000 μl of Phytophthora spore suspension on all the lobes of leaves in one square dish and cover the dish.
2) Infect the leaves with the fungus on and keep the leaves into the incubator at 17° C. in the dark for 24 h.
3) Transfer the plates for additional 3-5 days into the incubator at 22° C., with 12 h light, for sporangium growth.

### F. Tomato Leaf Discs Microplate Preparation for Screening

1) Take the 48 wells plate.
2) Prepare sterile water agar 0.5%, use it preheated, but cold.
3) Add 100 μl sterile water agar 0.5% to the microplate wells.
4) Put tomato leaf discs prepared from 3rd, 4th or 5th leaf, into microplate wells. Press the discs gently to ensure maximal contact with the liquid agar solution.

### G. Inoculation of Spores on Leaf Discs Microplate for Materials Screening

1) Insert the spore suspension into the microplate for testing.
2) Seal the chemicals microplate with transparent sealer.
3) Shake the microplate for 10 min at 2000 RPM to mix the materials with the added spore suspension.
4) Centrifugate the microplate at 1000 RCF for 1 s and stop to collect the liquid at the bottom of the plate.
5) Add 5 μl spore suspension onto the middle of each disc of the microplate.
6) Seal the leaf discs plate with transparent sealer.
7) Insert the sealed leaf discs plates into the incubator at 17° C. for 24 h in the dark and then at 22° C., with 12 h light/darkness regime for 3-5 days.
8) Perform the bioactivity evaluation.

### H. Bioactivity Evaluation

1) Screen plate at one time point: 5 days after suspension preparation using a ×5 magnification glass.
2) Report infected discs in Excel sheet:
   Type 1—if discs are fully infected;
   Type 2—inconclusive;
   Type 3—if discs are not infected at all.
3) Calculate the number of repeats of scores of 3 for each material.
4) Calculate the sum of scores of 3 for each material.
5) Best score was calculated as following: number of repeats=4, sum of scores=12.
6) “Hits” are those materials which have 4 or 3 repeats, and sum of 6-12.
   See results in Example 3.

### Example 2. Microplate-Based Screening of Dihydroquinidine or Dihydroquinine Against Pseudoperonospora cubensis

Background: Pseudoperonospora cubensis is an obligatory pathogen from Oomycetes which is very difficult to grow on synthetic medium. Therefore, the bioactivity screening system based on leaf discs prepared from detached cucumber leaves were used.

Summary: dihydroquinidine or dihydroquinine were dissolved in DMSO were added to cucumber leaf discs infected with Pseudoperonospora and the disease progress was monitored by visual inspection.

General description: Inoculation and maintenance on cucumber leaves, preparation of spore suspension, their growth on leaf discs in microplates and inspection by magnifying glass of Pseudoperonospora cubensis severity of infection.

The following materials, methods and equipment were used:

### Method:

### Preparation of Cucumber Seedling for Leaves Production for Inoculation:

1) Grow plants, in the growth room (27° C.), high light radiation.
2) Use standard garden soil.
3) Plant cucumber seeds.
4) Add fertilizer once a week.

### Preparation of Cucumber Leaves for Inoculation:

1) Put 3 (double) pieces of sterile paper in a square Petri dish.
2) Work in sterile conditions.
3) Use leaves from healthy plants. The leaves should be young and healthy, their size should fit to the square plate.
4) Cut the leaves by a sterile scalpel, leaving a long stem.
5) Add 10 ml sterile distilled water to wet the paper (the paper should be maximally wet, but without additional dripping water), discard excess of water. (High humidity will cause to growth of other undesired pathogens).
6) Fold the wet paper around the stem.
7) Put the leaf in a square Petri dish, abaxial side of the leaf up.
8) Cover the plate with its lid, but don't seal with nylon.
10) Add water every 2 days.

### Preparation of Inoculum for Leaves and Leaf Discs Infection:

1) Put cucumber leaf, infected with Pseudoperonospora (5-7 days after infection) in a sterile 50 ml tube, fill with 40 ml of fridge cold, sterile, distilled water.
2) Mix the tube gently by hand, or by vortex, to transfer sporangium into the water.
3) Filter the spore suspension through 16 layers of gauze into a 50 ml tube.
4) Collect the sporangium on a 5 micron membrane, and wash with sterile water.
5) Insert the membrane with the sporangium into a sterile 50 ml tube.
6) Add 5 ml sterile water into the tube to wash the spores from the membrane.
7) Calculate the spore concentration-use microscope with 200× magnification. A concentration of 100,000 sporangium/ml is expected (10 sporangium cells in the counting chamber middle square).
8) Dilute the spore suspension to get a concentration of 50,000 sporangium/ml.
9) Keep the tube on ice.
10) Use this suspension for inoculation.

### Cucumber Leaf Discs Microplate Preparation for Efficacy Evaluation:

1) Take a plate of 48 wells.
2) Prepare sterile water agar 0.5%, use it preheated, but cooled.
3) Add 200 μl sterile water agar 0.5% to the wells of the microplate.
4) Prepare leaf discs from cucumber leaves (same as used for the plates-young and healthy leaves).
5) Prepare the leaf discs immediately after cutting the leaves from the plant.
6) Insert into the wells of the plate, leaf discs with diameter as the well diameter (abaxial side of the leaf up). press the discs gently to ensure maximal contact with the liquid agar solution.
7) Do not seal with nylon.
   Inoculation of Spores on Detached Leaves for Maintenance of Pseudoperonospora cubensis:
1) Use a 200 μl pipette to apply small drops of Pseudoperonospora cubensis spore suspension on the leaf. Apply 600 μl suspension on one leaf.
2) Cover the dish don't seal it.
3) Insert the fungus on the leaves, into the incubator at 17° C. (the optimum is 18-22° C.), in the dark, for about 24 h, for the penetration stage.
4) Transfer the plates (not sealed) for additional 5-7 days into the incubator at 23° C., with 12 h light, for the growth and sporangium production.
5) Leaves should be infected, and the fungus should inoculate the leaf and cause yellow spots after 5 days with the following sporulation after 7 days.
6) The fungus should be viable for several days.
7) Store plates with sporangium in the fridge (not sealed, without water).

### Inoculation of Spores on Leaf Disc in Microplates:

1) Use spore suspension inoculum, as described above.
2) Mix 80 ul spore suspension with 20 ul material solution (control or dihydroquinidine or dihydroquinine) in a 1.5 ml tube or in a flat bottom 96 well plate.
3) For mixing 1.5 ml tubes-mix by vortex and pipette.
4) For mixing flat bottom 96 well plate:
   a. Seal the chemicals microplate with transparent sealer,
   b. Shake the chemicals microplate for 10 min at 2000 RPM to mix the materials with the added spore suspension.
   c. Centrifugate the chemicals microplate at 1000 RCF for 1 s and stop, to collect the liquid at the bottom of the plate.
5) Add 10 μl spore suspension onto the middle of each disc of the microplate, using a pipette. Don't seal the leaf discs plate.
6) Insert the leaf discs plates (not sealed) into the incubator (as for maintenance in plates) at 17° C. for 24 h in the dark and then at 23° C., with 12 h light, for 6 more days.
7) Screen for uninfected leaf discs after 7 days from inoculation.

### Fungal Growth Evaluation:

1) Perform the fungal growth evaluation 7 days after inoculation
2) Use a lamp for visual assessment of compounds effect on fungal growth overtime.
3) Perform visual evaluation of the plates after removing their cover, or by inspection of the back of the plate.
4) Compare the hyphal growth of each well to the hyphal growth of the control plate wells (wells containing active fungicides or DMSO solution).
5) Write the results on a special form: no symptoms on the leaf=3 (no growth of the fungus), yellow spots at the back, or gray mycelium on the abaxial side=0 (normal infection), inconclusive=2 (pale green, or other unexpected texture).
   See results in Example 3.

### Example 3. Results of In Vitro Experiments Based on Protocols of Examples 1-2

### In-Vitro Screening Matrix

Dihydroquinidine and dihydroquinine were screened against selected agricultural pests (as indicated in the tables below). The bioactivity values are in % and reflect the potential of eradicating the target pests.

Rules for Bioactivity Relative Value Calculation (Expressed in % from Maximal Value)

$$\begin{matrix}a . & \\ Phytophthora infestans , Pseudoperonospora cubenis - activity grade ( 1 / 2 / 3 ) \times repeats \# / 12 ( maximal value 3 \times 4 = 12 ) \times 100 & \end{matrix}$$

| | Bio-activity value | Bio-activity value |
|---|---|---|
| | Phytophthora | Pseudoperonospora |
| Compound | infestans | cubensis |
| DIHYDROQUINIDINE | 100 | 66 |
| DIHYDROQUININE | 83 | Not checked |

In summary, dihydroquinidine was demonstrated to be effective pesticides against the following pests: Phytophthora infestans (positive results in greenhouse in-vivo validation experiments provided) and Pseudoperonospora cubensis; dihydroquinine was affective against Phytophthora infestans.

### Statistical Analysis Used for Validation Experiments.

To evaluate the effect of a tested compounds in infected plants compared to control plants (infected but not treated) the data was analysed by Student's t-test and the p-value is calculated. The minimum number of repeats in each experiment was 3. Results were considered significant if p<0.05. The data presented as mean with standard error mean from biological replicates.

* means that p-value <0.05, ** means that p-value is <0.01, *** means that p-value is <0.001, # means that p-value <0.1, n.s.—means non-significant effect vs. control.

### Formulation Recipes Used for Validation Experiments.

### Preparation of Formulation 15

Three types of stock solutions were used for final dihydroquinidine formulation preparation at 400 ppm:
(A) Dihydroquinidine 1% suspension in water.
   1% of dihydroquinidine in water (50 mg of dihydroquinidine in 5 ml of water) was grinded using the grinder. The suspension was vigorously mixed and vortexed.
(B) 0.04% Xanthan Gum (thickener) in water (w/w).
(C) 0.6% Silwet® (a super-spreading non-ionic organosilicon surfactant co-polymer based on a trisiloxane ethoxylate) in water (w/w).

The final formulation which was applied to wheat plants is composed of:

4% of stock solution (A), 10% of stock solutions (B), 10% of stock (C), and 76% of water.

The final formulated hydroquinidine was applied as 400 ppm or diluted to the required concentrations and applied to plants.

### Preparation of Formulation 16

Three types of stock solutions were used for final dihydroquinidine formulation preparation at 400 ppm:
(A) Dihydroquinidine 8.3% solution in Genagen® 4296 (a dimethylamide non-water miscible solvent based on naturally derived fatty acids) with DL8/2 (mixture of non-ionic surfactants block polymer of ethoxy propoxy butanol and castor oil ethoxylate).
   Dihydroquinidine was grinded using grinder and 20.75 mg was dissolved in 200 μl of Genagen® 4296. The solution was mixed by vortex and sonicated under 50° C. until clear solution was obtained. 30 μl of DL8/2 was added and mixed. At this stage, 4/5 of final amount water for 400 ppm Dihydroquinidine solution was added the and mix was sonicated to get a stable emulsion.
(B) 0.04% Xanthan Gum in water (w/w).
(C) 0.6% Silwet® in water (w/w).

The final formulation which was applied to plants is composed of:

0.48% of stock solution (A), 10% of stock solutions (B), 10% of stock (C), and 79.52% of water. The final formulated dihydroquinidine was applied as 400 ppm or diluted to the required concentrations and applied to plants.

### Example 5. Validation In-Vivo Experiments in Tomato Infected with Phytophthora infestans Under Greenhouse Conditions

General description: Severity of late blight disease caused by Phytophthora infestans was evaluated following treatment with potentially bioactive compounds. Sporangium was used to infect 3-4 weeks-old tomato young plants following curative treatment potentially bioactive compounds.

### A. Pathogen Sporangium Preparation (Grown on Plates/Solid Media)

### Preparation of Sporangium Suspension

1) Put 10 lobes of 4 days old Phytophthora infected tomato leaves, in a sterile 50 ml tube.
2) Fill the tube with 40 ml of 4 ml of the cold sterile distilled water
3) Mix the tube gently, by hand, to release the sporangium into the water, but avoid damaging the leaf tissue.
4) Filter the spore suspension through 16 layers of miracloth into 50-ml tube.
5) Calculate the spore concentration using a microscope with 200× magnification, which is expected to be 3000 sporangium/ml.
6) Chill the tube on ice.

### B. Sporangium Washing and Concentration by Filtration

1) Prepare filtration system with filter membrane (in range of 0.45 μM to 5 μM pore size) and wash the membrane with sterile cold water.
2) Suspend and decant the spore suspension from the 50-ml tube slowly into the filtration system. Use low vacuum, do not let the membrane get dry-leave 4 ml unfiltered suspension on the filter.
3) Wash the spore to discard bacteria and other fungal spores with 40 ml of sterile cooled distilled water.
4) Repeat 5 times the washing process. Make sure the membrane will not get dry between the washing steps.
5) Collect the spore suspension into a clean 50-ml tube.
6) Insert the membrane using for filtration into the tube with the sporangium and gently suspend the sporangium left on the membrane.
7) Discard the membrane and wash and sterilize the filtration-vacuum system by hypochlorite solution (0.1%)—allow to stand for at least 1 hour in the hypochlorite solution.
8) Calculate sporangium concentration-using a microscope haemocytometer slide with ×200 magnification. The final concentration needed for inoculation is 6000 spore/ml.
9) Store the sporangium in the fridge.

### C. Plant/Seedling Germination Conditions

1) Tomato Ikram/Brigade/Shani cultivars (sensitive to Phytophthora) were germinated in seedlings tray using standard greenhouse soil mixture. Seedlings were grown in clean growing chamber with 24° C. temperature under 12 h light/12 h dark regime. Seedlings of 3-4 weeks old with 4 true leaves were used for experiments.
2) Plants needed for each treatment were transferred from the seedling' trays to a dedicated experimental tray.
3) Two leaves on each seedling were labelled by small plastic tags. On each labelled leaf the last largest 3 leaflets were used for the experiment.

### D. Inoculation Application (Preventative Approach)

In the preventative approach, inoculation was applied following two repeating treatments with bioactive compounds:
a) 10 μl drop of Phytophthora infestans freshly prepared (6000 spore/ml) spores' suspension was applied on each labelled leaflet (6 leaflets on each plant).
b) Inoculated plants were put into a humid box for 24 h.
c) After 24 h, the tray with the inoculated plants were removed from the humid box and placed in the greenhouse for further growth and disease development.

### E. Treatment Application (Preventative Approach)

1) 4 weeks-old healthy tomato seedlings with 4 true leaves were used. The last three leaflets of two mature leaves on each plant were labelled with a small plastic tag.
2) 48 h before inoculation (Day −2), plants were treated with formulated potentially bioactive compounds and respective control treatments using hand sprayer until the full drainage of the tomato leaves (1 ml/plant) on the upper and bottom side of the leaf.
3) 24 h before inoculation (Day −1), the plants were treated again with the same treatments.

### F. Growth and Analysis

1) Following treatment and inoculations, plants were grown under normal greenhouse conditions and watered according to need.
2) Five days following inoculation, disease was observed on the labelled leaves.
3) The labelled leaves were cut and collected, each treatment separately, and moved to the lab to measure the decay percentage expressed as disease severity in %.
4) Late blight symptoms should be observed as brownish-green spots which appear on the infected spot, then large areas of the leaves turn brown completely.

### Formulation Preparation

See formulation preparation in Formulation section in Example 3.

### Results

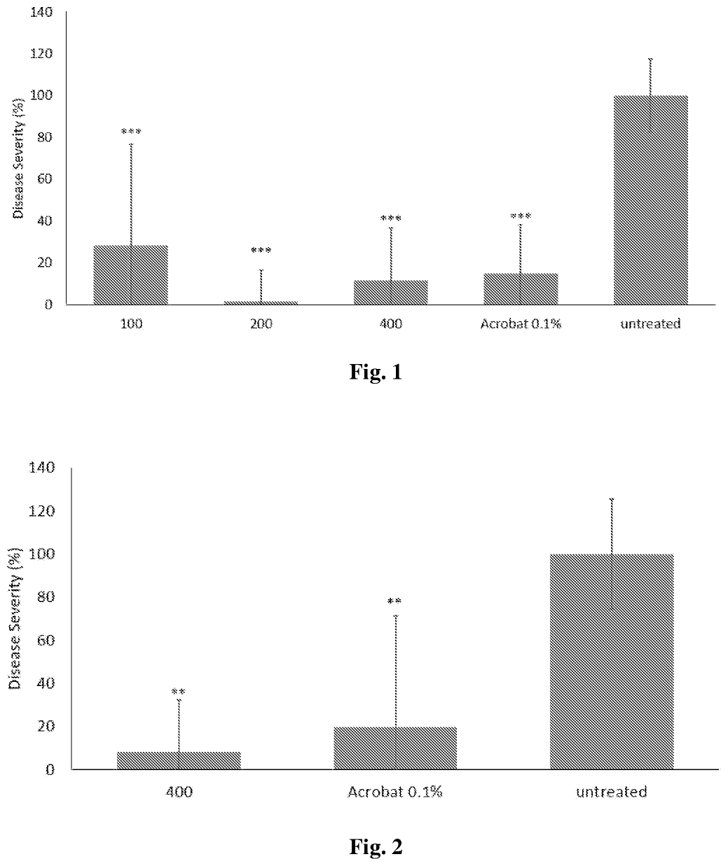

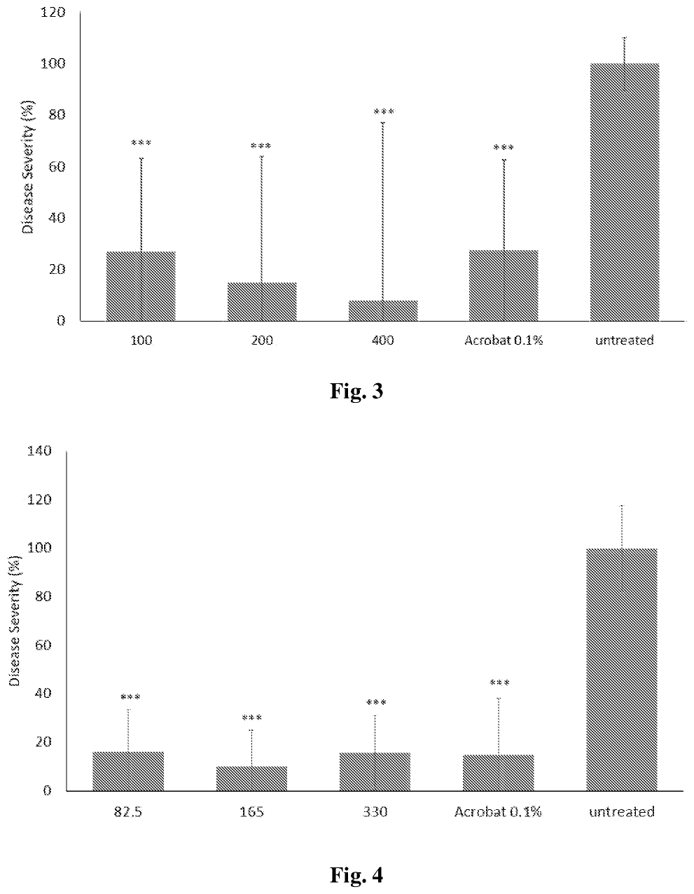

Four (4) independent experiments were conducted in tomato plants infected with Phytophthora under greenhouse conditions, where the potential of dihydroquinidine to prevent and control Phytophthora infestans (FIGS. 1-4) was estimated. Dihydroquinidine controlled the Phytophthora infection with the efficacy up to 89.38%.

While certain features of the present application have been illustrated and described herein, many modifications, substitutions, changes, and equivalents will be apparent to those of ordinary skill in the art. It is, therefore, to be understood that the appended claims are intended to cover all such modifications and changes as fall within the true spirit of the present application.

### REFERENCES

Che Z, Yang J, Sun D, Tian Y, Liu S, Lin X, Jiang J, Chen G. Synthesis of Novel (9S)-Acyloxy Derivatives of Quinidine and Dihydroquinidine as Insecticidal Agents. Chem. Biodivers. 2020 April; 17(4).
BE365389A: https://patents.google.com/patent/BE365389A/en?oq=BE365389A
Chen Y J, Ma K Y, Du S S, Zhang Z J, Wu T L, Sun Y, Liu Y Q, Yin X D, Zhou R, Yan Y F, Wang R X, He Y H, Chu Q R, Tang C. Antifungal Exploration of Quinoline Derivatives against Phytopathogenic Fungi Inspired by Quinine Alkaloids. J. Agric. Food Chem. 2021 Oct. 20; 69(41):12156-12170.
JP2003081945A: New quinoline compound having activity for controlling harmful microorganism.
Savory E A, Granke L L, Quesada-Ocampo L M, Varbanova M, Hausbeck M K, Day B. The cucurbit downy mildew pathogen Pseudoperonospora cubensis. Mol. Plant Pathol. 2011 April; 12 (3): 217-26.
Sedláková V., Dejmalová J., Hausvater E., Sedlák P., Doležal P. and Mazáková J. “Effect of Phytophthora infestans on potato yield in dependence on variety characteristics and fungicide control”. Plant Soil Environment, 57, 2011 (10): 486-491.
Yang G. Z., Zhu J. K., Yin X. D., Yan Y. F., Wang Y. L., Shang X. F., Liu Y. Q., Zhao Z. M., Peng J. W. and Liu H. Design, Synthesis, and Antifungal Evaluation of Novel Quinoline Derivatives Inspired from Natural Quinine Alkaloids. J Agric Food Chem. 2019 Oct. 16; 67(41):11340-11353.

1. A method for controlling, preventing, reducing or eradicating plant-pathogen infestation or instances thereof, or plant diseases, on a plant, plant organ, plant part, or plant propagation material, the method comprising applying to a plant, plant organ or plant propagation material, or to soil surrounding said plant, an effective amount of any one of compounds selected from the group consisting of dihydroquinidine and dihydroquinine, or agriculturally acceptable salts thereof, or a pesticide composition comprising at least one of said compounds, wherein said plant-pathogen is a member selected from a Heterokontophyta of the class Oomycota and a Heterokontophyta of the order Peronosporales.

2. The method of claim 1, wherein said plant diseases are selected from potato blight, Phytophthora palmivora in cacao, canker fruit rot diseases in tomato and pumpkins, Phytophthora spp. crown and collar rot in pome and stone fruit.

3. The method of claim 1, wherein said plant-pathogen is a member of the class Oomycota of the order Peronosporales.

4. The method of claim 3, wherein said Peronosporales plant-pathogen is a member of a family selected from Lagenidiaceae, Olpidiosidaceae, Sirolpidiaceae, Leptomitaceae, Albuginaceae, Peronosporaceae, Pythiaceae, Rhipidaceae, Ectrogellaceae, Haliphthoraceae, Leptolegniellaceae, and Saprolegniaceae. In a specific embodiment, the plant-pathogen is a member of the family Peronosporaceae.

5. The method of claim 4, wherein said plant-pathogen is from the genus Phytophthora.

6. The method of claim 5, wherein said plant-pathogen is the species Phytophthora infestans.

7. The method of claim 4, wherein said plant-pathogen is from the genus Pseudoperonospora.

8. The method of claim 7, wherein said plant-pathogen is from the species Pseudoperonospora cubensis.

9. A pesticide composition comprising a pesticidally effective amount of any one of compounds selected from the group consisting of dihydroquinidine and dihydroquinine, or agriculturally acceptable salts thereof.
